(19) United States
(12) Patent Application Publication
(10) Pub. No.: US 2005/0110334 A1
(43) Pub. Date: May 26, 2005

(54) Structure of turning control on a wheel

(76) Inventor: Chuan-Fu Kao, Pan-Chiao City (TW)

Correspondence Address: Chuan-Fu Kao, P.O. Box No. 6-57, Junghe, Taipei, 235, TW

(21) Appl. No.: 10/716,623

(22) Filed: Nov. 20, 2003

(51) Int. Cl. B60B 23/00

(52) U.S. Cl. 301/111.01

(57) ABSTRACT

A structure of turning control on a wheel, and mainly consists of a pair of symmetrical outer shells, within each of which is defined a circular trough, and two arched troughs extend from each of the circular troughs. A plurality of L-shaped latches are configured on an outer surface of each of the shells. A fixing axis with symmetrical protrusions is disposed between the two outer shells, and U-shaped spring pins are respectively disposed within the circular troughs of the outer shells so that the spring pins push against the protrusions. After the shells are placed in a center of a wheel, left and right directional control of the wheel is realized through synchronous motion of the protrusions within the arched troughs, the protrusions being held in place by the spring pins.

### BACKGROUND OF THE INVENTION

(a) Field of the Invention

The present invention relates to a turning control structure on a wheel, and more particularly to a structure that enables left and right turning control of a wheel.

(b) Description of the Prior Art

Wheels on a cart usually have an axis between them that is affixed to the cart, thus, a user must control turning of the moving cart with his own body, which is very cumbersome, and may result in the user losing patience, giving up or lowering his interest in riding the cart.

### SUMMARY OF INVENTION

The objective of the present invention is to provide a turning control structure on a wheel to make direction control easier, convenient, and less restrained.

The present invention consists of a pair of symmetrical outer shells, within each of which is a circular trough, and two arched troughs extend from each of the circular troughs. A plurality of L-shaped latches are configured on an outer surface of each of the shells. A fixing axis with symmetrical protrusions is disposed between the two outer shells, and U-shaped spring pins are respectively disposed within the circular troughs of the outer shells so that the springs push against the protrusions. After the shells are placed in a center of a wheel, synchronous sliding of the protrusions within the arched troughs and elasticity of the spring pins enable the wheel to swing left and right when in motion.

The present invention includes two protective rings, each of which have protruding pipes. Latches are configured within each of the protruding pipes to correspondi to the L-shaped latches on the outer shells. The protective rings are respectively positioned on two sides of a wheel, and rubber rings respectively affixed to the protective rings protect the outer shells from dirt.

To enable a further understanding of the said objectives and the technological methods of the invention herein, the brief description of the drawings below is followed by the detailed description of the preferred embodiment.

### BRIEF DESCRIPTION OF THE DRAWINGS

FIG. 1 shows a perspective view of the entire structural assembly according to the present invention.

FIG. 2 shows an exploded perspective view of the entire structural assembly according to the present invention.

FIG. 3 shows a cross-sectional schematic view of the assembled unit according to the present invention.

FIG. 4 shows a schematic view of the present invention in use.

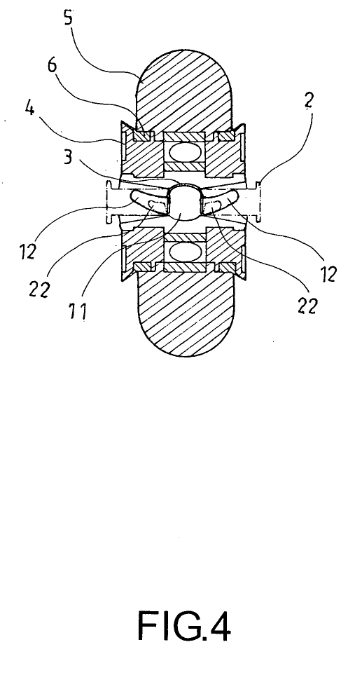

FIG. 5 shows another schematic view of the present invention in use.

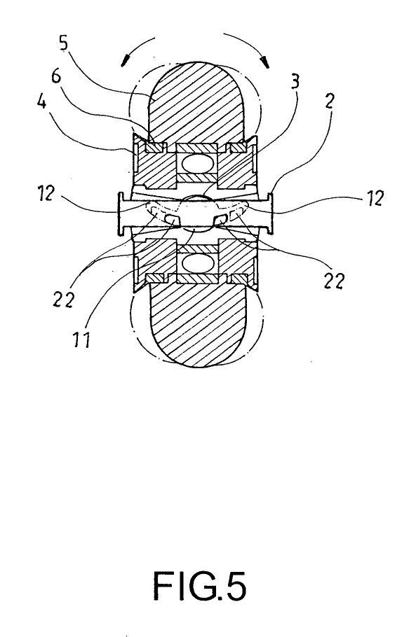

### DETAILED DESCRIPTION OF THE PREFERRED EMBODIMENTS

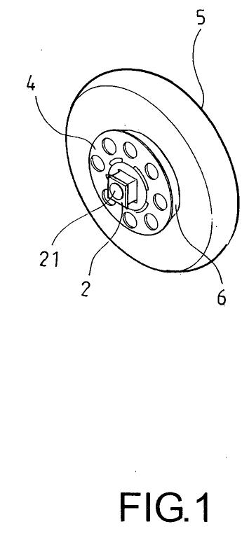

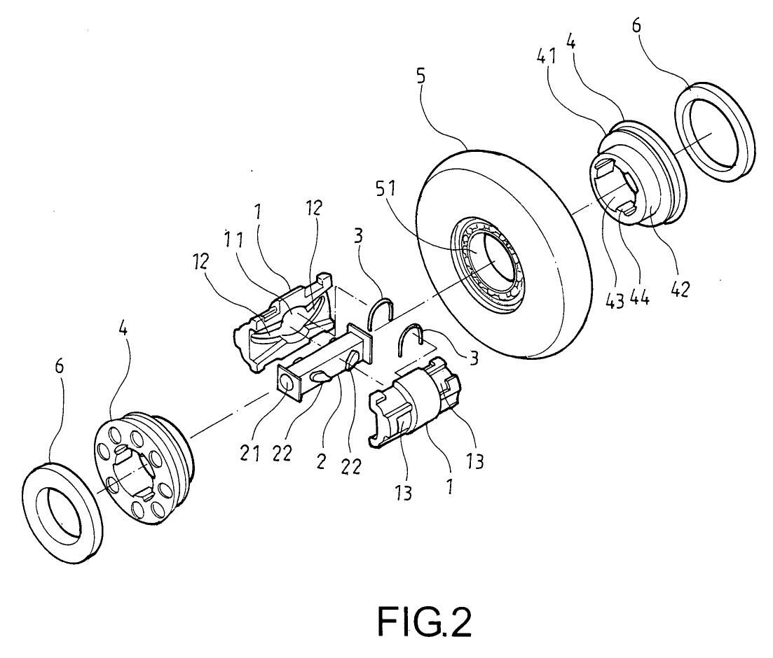

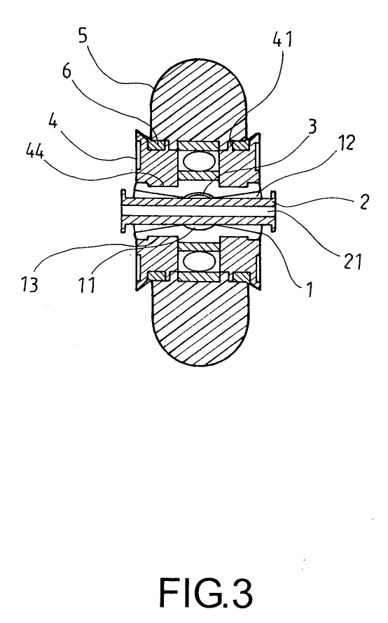

Referring to FIGS. 1-3, the present invention comprises two outer shells (1), within each of which is a circular trough (11), and two arched troughs (12) extend from each of the circular troughs (11). An outer surface of each of the outer shells (1) assumes a round shape, and two sides of each of the outer surface are defined with L-shaped latches (13).

A fixing axis (2) is disposed within the two outer shells (1), within which is a lengthwise hole (21) penetrates the fixing axis (2), and protrusions (22) are configured on outer surfaces of the fixing axis (2). Two U-shaped spring pins (3) are disposed in the circular troughs (11) of the outer shells (1) and hold in place the two outer shells (1) after being snapped together so that the protrusions (22) are disposed within the arched troughs (2), thereby enclosing the fixing axis (2)

Each of two protective rings (4) is provided with a closing part (41) and a protruding pipe (42). A centric hole (43) is defined in each of the protruding pipes (42), within which are configured latches (44) to correspond to the L-shaped latches (13) on the outer shells (1).

When assembling the aforesaid parts, the outer shells (1) are disposed in a center (51) of a wheel (5), and the protective rings (4) are respectively disposed on two ends of the outer shells (1) whereupon the latches (44) are snapped into the corresponding L-shaped latches (13). Rubber rings (6) are then respectively placed around the closing parts (41) of the protective rings (4), thereby rendering the outer shells (1) sealed from dirt. When the wheel (5) is in motion, the protrusions (22) of the fixing axis (2) are able to slide within the arched troughs (12) while being held in place by the spring pins (3), thereby controlling left and right turning of the wheel (5).

In conclusion, a structure for turning control of a wheel of the present invention uses the outer shells (1) and a fixing axis (2) to achieve easy directional control of a wheel. Hence, the present invention provides a practical and innovative structure.

It is of course to be understood that the embodiment described herein is merely illustrative of the principles of the invention and that a wide variety of modifications thereto may be effected by persons skilled in the art without departing from the spirit and scope of the invention as set forth in the claims.

1. A structure of turning control on a wheel comprising
two outer shells, within each of which is defined a circular trough, two arched troughs respectively extend from two sides of the circular troughs, an outer surface of each of the outer shells assumes a round shape, and L-shaped latches are configured on two sides of the round surface of each of the outer shells;
a fixing axis having a lengthwise hole is disposed between the two outer shells, and protrusions are configured on surfaces of the fixing axis,
two U-shaped spring pins that are respectively disposed in the circular troughs of the outer shells, and configured to push against the protrusions on the fixing axis;
two protective rings with closing parts and protruding pipes, each of the protective rings is defined with a centric hole, and latches are configured within the centric holes to correspond to the protrusions of the fixing axis;
two rubber rings that are disposed around the closing parts;
and assembled by snapping the outer shells together, and disposing in a center of a wheel, whereafter the protective rings are respectively disposed on two sides of the outer shells, the protrusions of the fixing axis are thus able to slide within the arched troughs, and are held in place by the spring pins, thereby enabling left and right turning control of the wheel.
